(19) United States
(12) Patent Application Publication
(10) Pub. No.: US 2026/0147693 A1
(43) Pub. Date: May 28, 2026

(54) TEST-CASE GENERATION USING A GRAPH MODEL AND RAG SYSTEM

(71) Applicant: International Business Machines Corporation, Armonk, NY (US)

(72) Inventors: Wen Wang, Beijing (CN); Zhong Fang Yuan, Xi'an (CN); He Li, Beijing (CN); Li Juan Gao, Xi'an (CN); Tong Liu, XI'AN (CN)

(21) Appl. No.: 18/956,241

(22) Filed: Nov. 22, 2024

(51) Int. Cl. G06F 11/36

(52) U.S. Cl. CPC G06F 11/3688

(57) ABSTRACT

An example operation includes one or more of extracting testing targets of a software system from a document that describes requirements of the software system, generating a graph model which comprises nodes corresponding to the testing targets and edges between the nodes corresponding to correlations between the testing targets, receiving a request to generate a test case for a testing target among the testing targets, retrieving graph data from the graph model based on the testing target and executing a machine learning model on the graph data to generate the test case for the testing target, and executing the test case on the software system to generate test results.

### BACKGROUND

The present invention relates to testing software systems and harnessing capabilities of various types of artificial intelligence working together to achieve new benefits.

### SUMMARY

One example embodiment provides a computer-implemented method that may include one or more of extracting testing targets of a software system from a document that describes requirements of the software system, generating a graph model which comprises nodes corresponding to the testing targets and edges between the nodes corresponding to correlations between the testing targets, receiving a request to generate a test case for a testing target among the testing targets, retrieving graph data from the graph model based on the testing target and executing a machine learning model on the graph data to generate the test case for the testing target, and executing the test case on the software system to generate test results.

Another example embodiment provides a computer system that may include a processor set, a set of one or more computer-readable storage media, and program instructions, collectively stored in the set of one or more storage media, that cause the processor set to perform computer operations that may include one or more of extracting testing targets of a software system from a document that describes requirements of the software system, generating a graph model which comprises nodes corresponding to the testing targets and edges between the nodes corresponding to correlations between the testing targets, receiving a request to generate a test case for a testing target among the testing targets, retrieving graph data from the graph model based on the testing target and executing a machine learning model on the graph data to generate the test case for the testing target, and executing the test case on the software system to generate test results.

A further example embodiment provides a computer program product that may include a set of one or more computer-readable storage media, and program instructions, collectively stored in the set of one or more computer-readable storage media, for causing a processor set to perform computer operations that may include one or more of extracting testing targets of a software system from a document that describes requirements of the software system, generating a graph model which comprises nodes corresponding to the testing targets and edges between the nodes corresponding to correlations between the testing targets, receiving a request to generate a test case for a testing target among the testing targets, retrieving graph data from the graph model based on the testing target and executing a machine learning model on the graph data to generate the test case for the testing target, and executing the test case on the software system to generate test results.

### BRIEF DESCRIPTION OF THE DRAWINGS

FIG. 1 is a diagram illustrating a computing environment according to an embodiment of the instant solution.

FIG. 2 is a diagram illustrating a system for generating test cases for testing a software system according to examples and features of the instant solution.

FIG. 3A is a diagram illustrating a process of building a graph based on requirements-related documents according to examples and features of the instant solution.

FIG. 3B is a diagram illustrating a process of refining the graph based on additional features of the requirements according to examples and features of the instant solution.

FIG. 3C is a diagram of generating a test case using a RAG-based architecture according to examples and features of the instant solution.

FIG. 3D is a diagram illustrating a process of executing a test case according to examples and features of the instant solution.

FIG. 4A is a flow diagram illustrating a method according to examples and features of the instant solution.

FIG. 4B is a flow diagram illustrating a method according to additional examples and features of the instant solution.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

The processes of designing, executing, and managing test cases are critical in system validation. Typically, testers develop test cases based on a variety of system requirements, including functional requirements (e.g., business rules, authentication, certification, external interfaces) and non-functional requirements (e.g., performance, response time, resource utilization, availability, capacity). While tools exist to automate the execution of test cases, the generation of test cases remains predominantly a manual task.

According to an aspect of the example embodiments, a computer-implemented method is provided that includes extracting testing targets of a software system from a document that describes the requirements of the software system, generating a graph model that comprises nodes corresponding to the testing targets and edges between the nodes representing correlations between the testing targets, and receiving a request to generate a test case for a testing target. The method further includes retrieving graph data from the graph model based on the testing target and executing a machine learning model on the graph data to generate the test case for the testing target, followed by executing the test case on the software system to generate test results. The technical effect of the method is the automatic generation of a test case for a software system using its document content. A technical advantage of the method is that multiple test cases can be generated simultaneously by scaling the system.

In some embodiments, the computer-implemented method may further include executing the machine learning model on a predefined prompt and the document to identify the functional and non-functional requirements of the software system and generating nodes in the graph model for both the functional and the non-functional requirements. The technical effect of this method is the construction of a graph with the software system's requirements for use in a retrieval-augmented generation (RAG)-based architecture that is used to produce more accurate and better-informed responses to various queries or requests.

In some embodiments, the computer-implemented method may further include generating an automation script based on execution of the machine learning model on the graph data, wherein the executing the test case includes executing the test case based on the automation script. The technical effect of this method is that both the software test case and the automation script for executing the software test case can be generated automatically.

In some embodiments, the computer-implemented method may further include retrieving relevant content associated with the testing targets from additional sources and modifying the nodes in the graph model to include the relevant content associated with the testing targets, prior to retrieving the graph data. The technical effect of this method is that additional attributes of the software system extracted from additional sources such as best practices of an organization, etc., can be used to enhance the graph used for RAG-based retrieval. RAG stands for retrieval-augmented generation and is an area of artificial intelligence.

In some embodiments, the computer-implemented method may include retrieving at least one of user interface (UI), design features, data model features, and API features from at least one of text, images, video content, and audio content. The technical effect of this method is that features specific to software development can be used to enhance the graph used for RAG-based retrieval.

In some embodiments, the computer-implemented method may further include generating a prompt with descriptions of the test case and relevant content to be used for the test case, wherein executing the machine learning model further includes executing the machine learning model on the prompt to generate the test case. The technical advantage of this method is adding an additional description of the test case to the input of the machine learning model to further define and improve the quality of the test case being generated.

In some embodiments, the computer-implemented method may further include determining a correlation between a first testing target and a second testing target based on semantic analysis of the document, and establishing an edge between a first node in the graph model corresponding to the first testing target and a second node in the graph model corresponding to the second testing target. The technical effect of this feature is improving the correlations amongst requirements such that any correlation can be included in the test case that is generated by the method.

According to an aspect of the example embodiments, there is provided a computer system that includes a processor set, a set of one or more computer-readable storage media, and program instructions, collectively stored in the set of one or more storage media, for causing the processor set to perform operations that include extracting testing targets of a software system from a document that describes requirements of the software system, generating a graph model which comprises nodes corresponding to the testing targets and edges between the nodes corresponding to correlations between the testing targets, receiving a request to generate a test case for a testing target among the testing targets, retrieving graph data from the graph model based on the testing target and executing a machine learning model on the graph data to generate the test case for the testing target, and executing the test case on the software system to generate test results. A technical effect of the computer system is that a test case can be generated automatically for a software system using document content of the software system. A technical advantage of the computer system is that multiple test cases can be generated at the same time by simply scaling the system.

In some embodiments, the processor set may perform operations that include executing the machine learning model on a predefined prompt and the document to identify functional requirements and non-functional requirements of the software system and generating nodes in the graph model for the functional requirements and the non-functional requirements. A technical effect of this computer system is building a graph with requirements of the software system for use by a RAG-based architecture.

In some embodiments, the processor set may perform operations that further include generating an automation script based on execution of the machine learning model on the graph data, wherein executing the test case includes executing the test case based on the automation script. The technical effect of this computer system is that both the software test case and the automation script for executing the software test case can be generated in an automated manner.

In some embodiments, the processor set may perform operations that further include retrieving relevant content associated with the testing targets from additional sources and modifying the nodes in the graph model to include the relevant content associated with the testing targets, prior to retrieving the graph data. The technical effect of this computer system is that additional attributes of the software system extracted from additional sources, such as best practices of an organization, etc., can be used to enhance the graph used for RAG-based retrieval.

In some embodiments, the processor set may perform operations that include retrieving at least one of UI design features, data model features, and API features from at least one of text, images, video content, and audio content. The technical effect of this computer system is that features specific to software development can be used to enhance the graph used for RAG-based retrieval.

In some embodiments, the processor set may perform operations that further include generating a prompt with descriptions of the test case and relevant content to be used for the test case, wherein executing the machine learning model further includes executing the machine learning model on the prompt to generate the test case. The technical advantage of this computer system is adding additional description of the test case to the input of the machine learning model to further define and improve the quality of the test case being generated.

In some embodiments, the processor set may perform operations that further include determining a correlation between a first testing target and a second testing target based on semantic analysis of the document, and establishing an edge between a first node in the graph model corresponding to the first testing target and a second node in the graph model corresponding to the second testing target. The technical effect of this feature is improving the correlations amongst requirements such that the correlations can be included in the test case that is generated by the method.

According to an aspect of the example embodiments, a computer program product is provided that includes a set of one or more computer-readable storage media, and program instructions, collectively stored in the set of one or more computer-readable storage media, for causing a processor set to perform computer operations that include extracting testing targets of a software system from a document that describes requirements of the software system, generating a graph model which comprises nodes corresponding to the testing targets and edges between the nodes corresponding to correlations between the testing targets, receiving a request to generate a test case for a testing target among the testing targets, retrieving graph data from the graph model based on the testing target and executing a machine learning model on the graph data to generate the test case for the testing target, and executing the test case on the software system to generate test results. A technical effect of the computer program product is that a test case can be generated automatically for a software system using document content of the software system. A technical advantage of the computer program product is that multiple test cases can be generated at the same time by simply scaling the system.

In some embodiments, the computer operations may further include executing the machine learning model on a predefined prompt and the document to identify functional requirements and non-functional requirements of the software system and generating nodes in the graph model for the functional requirements and the non-functional requirements. A technical effect of this computer program product is building a graph with requirements of the software system for use by a RAG-based architecture.

In some embodiments, the computer operations may further include generating an automation script based on execution of the machine learning model on the graph data, wherein executing the test case includes executing the test case based on the automation script. The technical effect of this computer program product is that both the software test case and the automation script for executing the software test case can be generated in an automated manner.

In some embodiments, the computer operations may further include retrieving relevant content associated with the testing targets from additional sources and modifying the nodes in the graph model to include the relevant content associated with the testing targets, prior to retrieving the graph data. The technical effect of this computer program product is that additional attributes of the software system extracted from additional sources, such as best practices of an organization, etc., can be used to enhance the graph used for RAG-based retrieval.

In some embodiments, the computer operations may include retrieving at least one of UI design features, data model features, and API features from at least one of text, images, video content, and audio content. The technical effect of this computer system is that features specific to software development can be used to enhance the graph used for RAG-based retrieval.

In some embodiments, the computer operations may further include generating a prompt with descriptions of the test case and relevant content to be used for the test case, wherein executing the machine learning model further includes executing the machine learning model on the prompt to generate the test case. The technical advantage of this computer program product is adding additional description of the test case to the input of the machine learning model to further define and improve the quality of the test case being generated.

In some embodiments, the computer operations may further include determining a correlation between a first testing target and a second testing target based on semantic analysis of the document, and establishing an edge between a first node in the graph model corresponding to the first testing target and a second node in the graph model corresponding to the second testing target. The technical effect of this feature is improving the correlations amongst requirements such that such correlation can be included in the test case that is generated by the method.

The RAG-based and graph-based system described herein may be hosted within a software application, a service, or the like, which may be hosted by a host platform such as a cloud platform, a web server, a database, or the like.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure, including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer can deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community with shared concerns (e.g., mission, security requirements, policy, and compliance considerations). It may be managed by organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

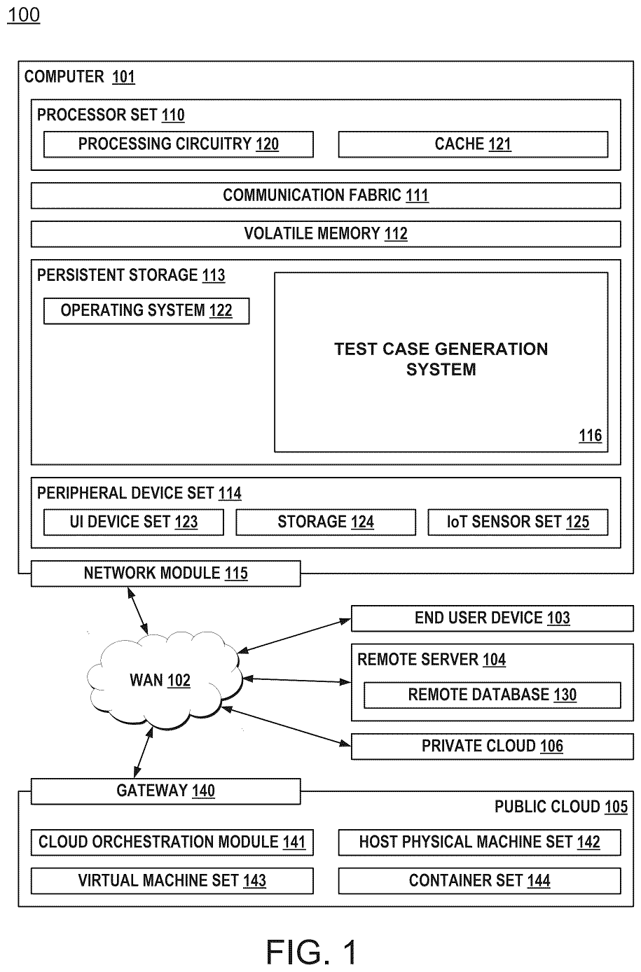

FIG. 1 illustrates a computing environment 100 according to an embodiment of the instant solution. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 1, computing environment 100 contains an example of an environment for executing at least some of the computer code involved in performing the inventive methods, such as a test case generation system 116. In addition to block 116, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 116, as identified above), peripheral device set 114 (including UI, device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically the computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 116 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 116 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi® signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi® network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The example embodiments are directed to a test case generation system that can automate the generation of test cases using document data related to the system being tested. The test case generation system includes a graph-building process which is used to extract requirements from the document data, including functional requirements and non-functional requirements, and build a graph model of the requirements. Furthermore, the graph-building process can enhance/enrich the graph model with additional data about the requirements including UI, API, and business requirements which need to be tested.

For example, based on sources such as requirement documents, design documents, API documents, and meeting records as input, data in different modalities such as text, images, voice, and videos may be extracted to build a cross-modal knowledge graph. Utilizing cross-modal large models, test cases can be automatically generated. Based on requirement documents (including functional requirements and non-functional requirements) and relevant regulations, the instant system can extract test targets and build a graph. The graph may include a plurality of nodes corresponding to test targets (e.g., requirements) and edges between the nodes indicating correlations between the requirements.

Furthermore, the graph may be enhanced with additional information for each test target, including UI design requirements, user experience (UX) design requirements, technical design requirements, data model requirements, API functionality, relevant meeting fragment data, and the like. The test case generation system may integrate the overall correlation relationship to build a cross-modal knowledge graph.

Based on the cross-modal knowledge graph and graph retrieval technology, the system can query the nodes related to each test target to retrieve relevant data for a particular requirement and execute a machine learning model such as a large language model (LLM) on the relevant data to generate a test case that include testing steps for testing requirements. That is, the system may include a RAG-based architecture that retrieves data from a graph, rather than from documents, and inputs the retrieved data to a LLM. In addition, the machine learning model can generate an automation script which can be executed by a testing tool for carrying out the test case on the software system being tested.

The system described herein can automatically design and generate test cases with multi-modal graph-RAG techniques. Some of the benefits of the example embodiments include generating test cases, test steps, and test scripts in an automated manner, which highly improves the overall testing efficiency because requirements can be fully identified and tested in an automated manner without requiring human intervention which can often create errors or miss requirements that should be tested. Furthermore, the system can be shared and transferred during different projects. Furthermore, the system can flexibly select both relevant testing cases and relevant reference materials with graph analysis techniques enabling a fine-tuned retrieval process for inputting data to the LLM.

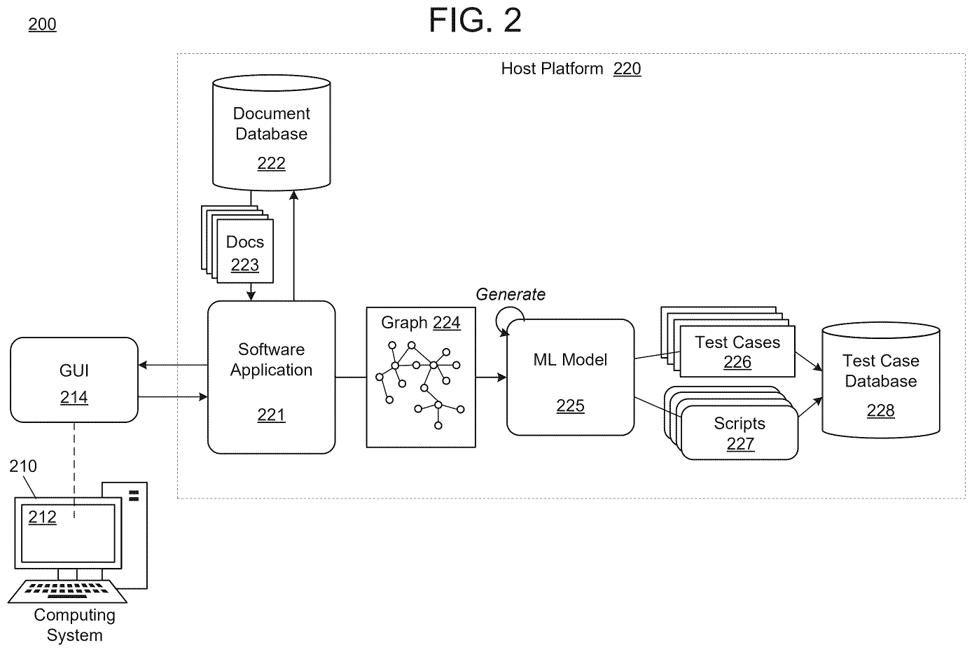

FIG. 2 illustrates a system 200 for generating test cases to test a software system according to examples and features of the instant solution. Referring to FIG. 2, a host platform 220 hosts a software application 221, which may perform the automated test case generation process described herein. For example, the host platform 220 may refer to a cloud platform, a web server, a database, a distributed system, or the like. The software application 221 may be accessed by a computing system 210 over a network, such as the Internet. For example, the software application 221 may be a progressive web application or similar, accessible from a browser installed on the computing system 210 by entering a URL of the software application 221 into the browser. Alternatively, the software application 221 may be a mobile application or the like.

In this example, the software application 221 provides a graphical user interface (GUI) 214 which can be viewed on a display device 212 of the computing system 210. For example, the GUI 214 may be included within a page or pages of the software application 221. The user may input commands via the GUI 214 which provides instructions on test cases to generate and execute. For example, the user may input an identifier of a software system (e.g., software application, service, machine learning model, application programming interface, or the like) with a request to generate a test case for the software system.

In response to receiving the input, the software application 221 may retrieve documents 223 associated with the software system from a document database 222. The software application 221 may identify requirements (e.g., functional requirements, non-functional requirements, etc.) of the software system from the documents 223. For example, the software application 221 may use natural language processing (NLP), rules, machine learning, or the like, to identify the requirements. Furthermore, the software application 221 may build a graph 224 that includes the requirements therein (as nodes) and edges between the nodes which represent correlations between the requirements.

According to various embodiments, a machine learning (ML) model 225 with a RAG-based architecture may retrieve content from the graph 224, for example, content specific to a single requirement, and generate a test case based on execution of the ML model 225 on the retrieved graph content. The process may be performed for all of the requirements in the graph 224 resulting in test cases 226 for testing the requirements, respectively. The test cases may include steps for testing the requirements, descriptive content that describes how the test is to be performed, commands that must be entered by a user into a UI, etc., and the like. In addition, the ML model 225 may generate scripts 227 for executing the test cases 226. The scripts 227 may be automation scripts that include instructions for executing the test cases 226 on the software system without user involvement. The test cases 226 and the scripts 227 may be stored within a test case database 228. Although not shown in FIG. 2, it should also be appreciated that the ML model 225 may generate instructions (e.g., a description of steps) for a tester to perform, for example, via inputs on a UI to perform the test. However, not all tests will require user input, and this is just an example.

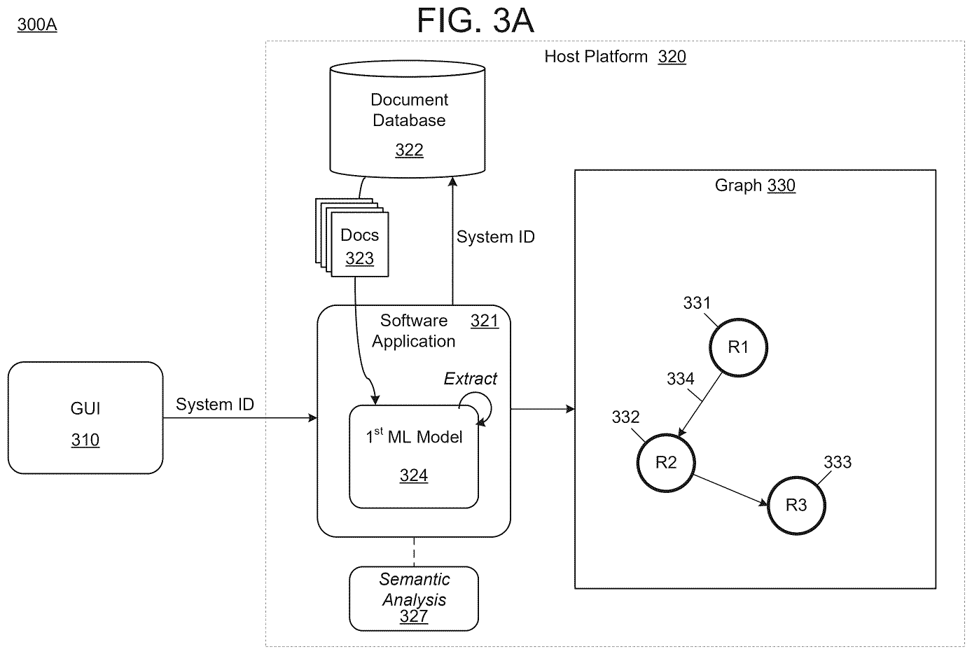

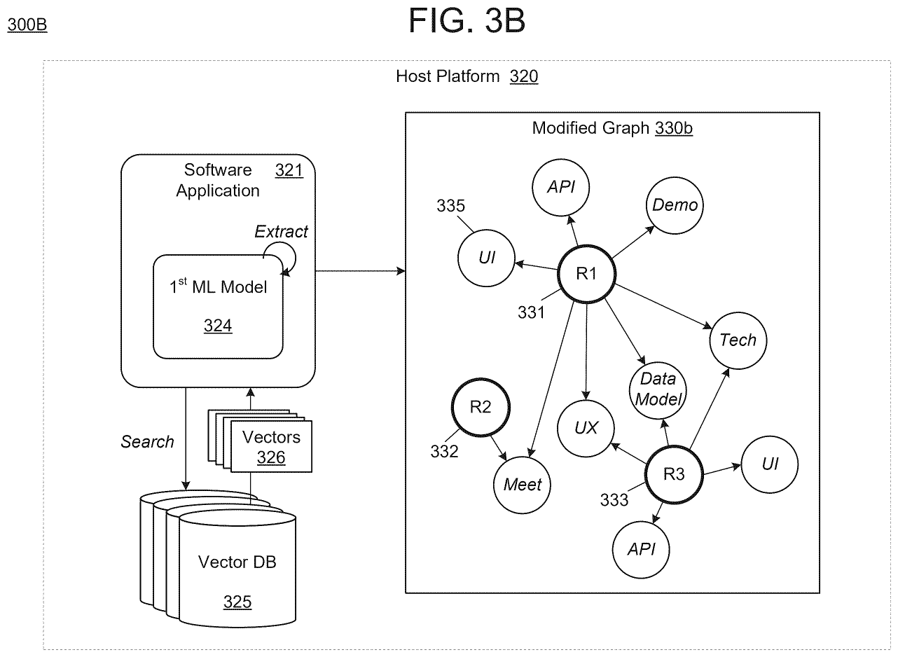

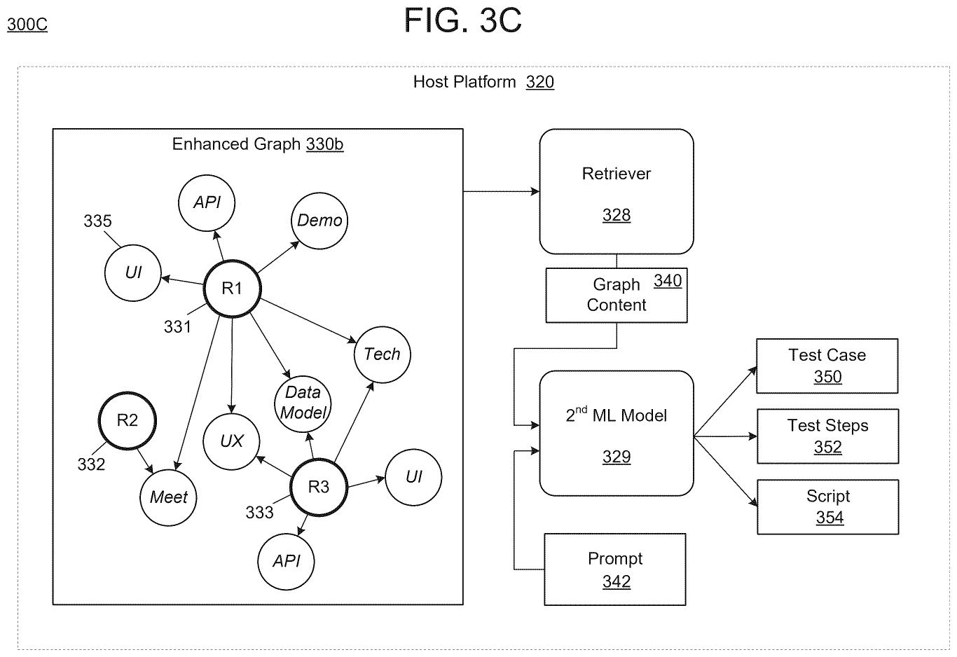

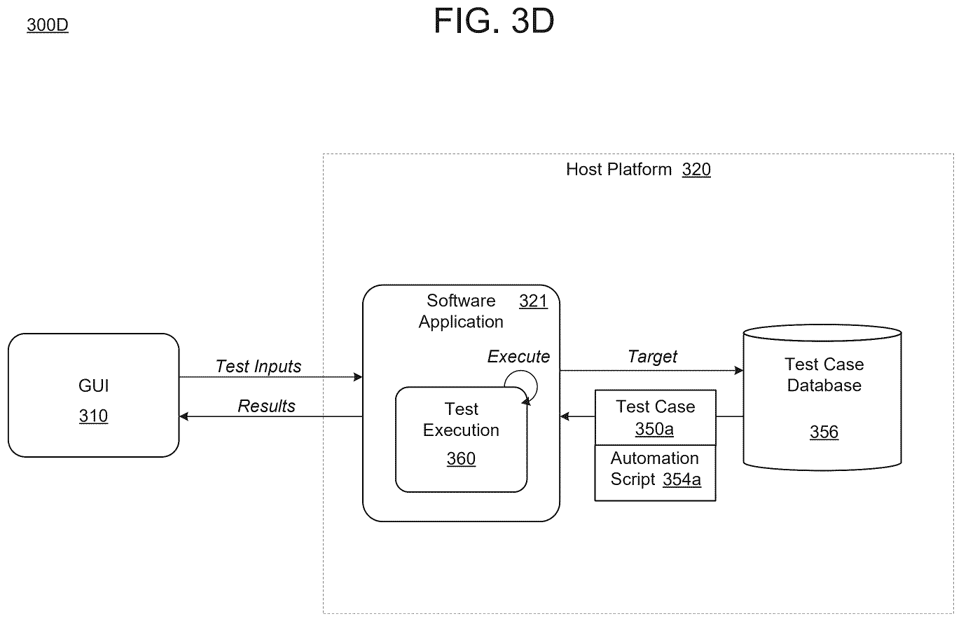

FIG. 3A illustrates a process 300A of building a graph based on requirement-related documents according to examples and features of the instant solution. Referring to FIG. 3A, a software application 321 hosted by a host platform 320 may extract testing targets from documents 323 associated with the software system. The testing targets may refer to requirements of the software system such as functional requirements (e.g., what the software should do, etc.) and non-functional requirements (e.g., a quality attribute of the system, how the system should fulfill the functional requirements, etc.).

In this example, a user may provide an identifier of a software system to the software application 321, for example, via an input on a GUI 310. The system identifier may include a name of the software, a storage path/location, a version identifier, a URL, and/or the like. The software application 321 may receive the system identifier and query a document database 322 for the documents 323 which are related to the system identifier. The documents 323 may include requirement documents generated by a user/developer. As another example, the documents 323 may include meeting notes, use case models, API documents, and the like. The documents 323 may also include files, or the like, with different modalities of data such as text, images, audio, video, etc.

The software application 321 may identify requirements from the documents 323 using various mechanisms. In the example of FIG. 3A, the software application 321 may include a first ML model 324 that is configured to identify the testing targets of the system. As another example, the software application 321 may use predefined rules, natural language processing, deep learning, and/or the like, for identifying the testing targets. In the example of FIG. 3A, the software application 321 identifies three requirements (three testing targets) and generates a graph 330 with nodes 331, 332, and 333 corresponding to the three requirements.

In addition, the software application 321 may analyze the correlation between test targets and generate edges 334 between nodes in the graph corresponding to the correlations between the testing targets. The correlation can be calculated, for example, by extracting a correlation that has been built into the document. Such a correlation built into the document is the correlation between each use case based on a use-case model. As another example, the correlation may be extracted based on a document semantic analysis process 327, which can be executed by the software application 321, and which can be used to calculate text correlation and build correlation relationships for highly relevant test targets.

FIG. 3B illustrates a process 300B of refining the graph 330 based on additional features of the requirements to generate a modified graph 330b according to examples and features of the instant solution. Referring to FIG. 3B, the software application 321 may extract vectors 326 of data related to each of the testing targets of the software system and enhance the graph 330 with additional content related thereto to generate the modified graph 330b. For example, for each test target, the software application 321 may extract relevant information including UI design content, UX design content, technical design content, a data model, API documentation, meeting notes, and the like.

For example, the software application 321 (or another program not shown) may include different handlers for extracting the different types of content, data models, documentation, etc. from documents and storing the content within a vector database 325. For example, the documents, etc. may be chunked and converted into vectors which are stored within the vector database 325. The software application 321 may identify a testing target in the graph 330 and find relevant vectors of content associated with the testing target in the vector database 325. For example, the software application 321 may retrieve vectors 326 from the vector database 325 and use the additional content to build additional nodes 335 in the graph 330 and edges between the nodes, resulting in a modified graph 330b.

FIG. 3C illustrates a process 300C of generating a test case using a RAG-based architecture according to examples and features of the instant solution. RAG stands for retrieval-augmented generation and is an area of artificial intelligence. Referring to FIG. 3C, the system described herein may include a second machine learning model 329 which is configured to generate test cases for testing the software system. In this example, the machine learning model 329 may include a RAG-based architecture including a retriever 328 which is configured to search the modified graph 330b and identify graph content 340 that is related to a particular testing target.

For example, the retriever 328 may receive an identifier of a testing target from the software application 321 and may identify a portion of the modified graph 330b (e.g., graph content 340) which includes relevant content related to the testing target. The retriever 328 may pass the graph content 340 to the machine learning model 329 as input. In response, the ML model 329 may generate a test case or cases 350 which include a description of test steps 352 and an automation script 354. For example, after getting all the relevant chunks from the graph, the software application 321 can build a prompt 342 based on a prompt template, combine all the relevant information, and use the ML model 329 to generate test cases. For each test case, if needed, the software can further call the machine learning model 329 to generate testing steps. Furthermore, if the testing case can be executed automatically with some automated applications, the software can further call machine learning model 329 to generate one or more relevant testing scripts for each test case or testing steps.

In some embodiments, the software application 321 may input a prompt 342 to the machine learning model 329 with instructions regarding the test case to generate. In response, the ML model 329 may generate the test case source code and store it within an executable file. The ML model 329 may also generate a description of the test steps 352 to be performed by the tester (if necessary) and compose a document with the description of the test steps 352. The ML model 329 may also generate an automation script 354 for the test case 350, which can execute the test case 350 automatically.

FIG. 3D illustrates a process 300D of executing a test case according to examples and features of the instant solution. Referring to FIG. 3D, the software application 321 may automatically execute a test case 350a based on an automation script 354a for the test case 350a. The software application 321 may retrieve the test case 350a and the automation script 354a from a test case database 356 and execute the test case 350a using the automation script 354a via a test execution process 360. The user may interact with the test being performed via the GUI 310, for example, by inputting commands if necessary. Furthermore, the results of the execution of the test case can be displayed on the GUI 310 by the software application 321.

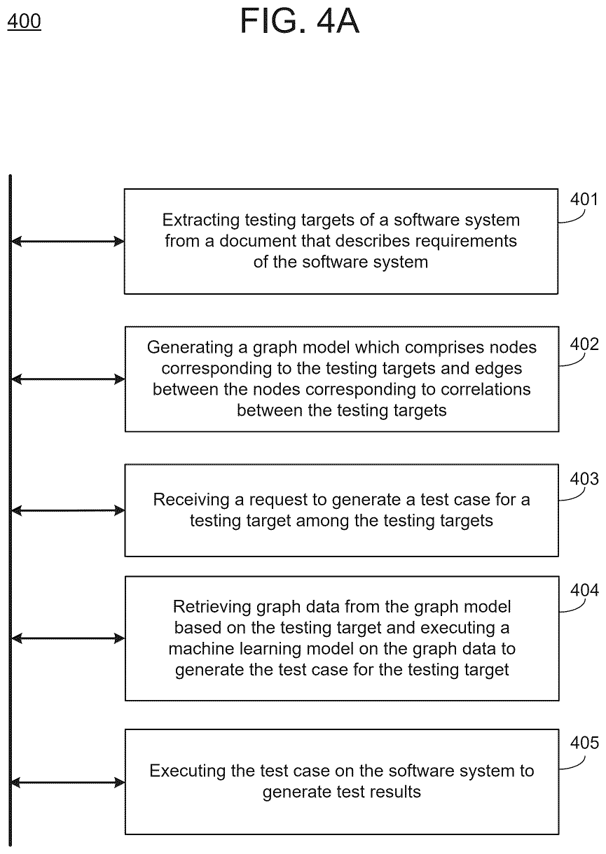

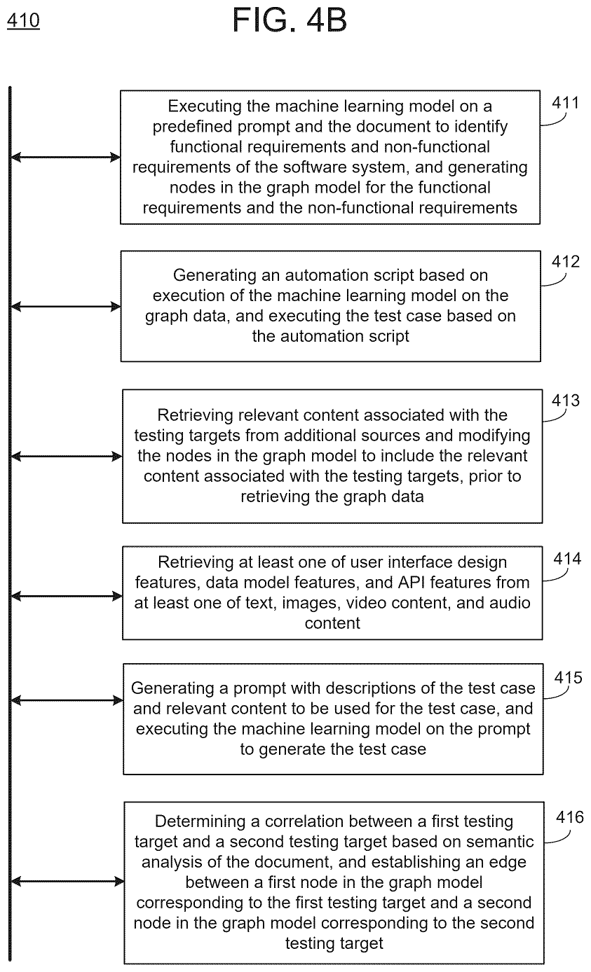

FIG. 4A illustrates a flow diagram of a method 400, according to example embodiments. Referring to FIG. 4A, in 401, the method may include extracting testing targets of a software system from a document that describes requirements of the software system. In 402, the method may include generating a graph model which comprises nodes corresponding to the testing targets and edges between the nodes corresponding to correlations between the testing targets. In 403, the method may include receiving a request to generate a test case for a testing target among the testing targets. In 404, the method may include retrieving graph data from the graph model based on the testing target and executing a machine learning model on the graph data to generate the test case for the testing target. In 405, the method may include executing the test case on the software system to generate test results.

FIG. 4B illustrates a flow diagram of a method 410, according to example embodiments. Referring to FIG. 4B, in 411, the method may include executing the machine learning model on a predefined prompt and the document to identify functional requirements and non-functional requirements of the software system, and generating nodes in the graph model for the functional requirements and the non-functional requirements. In 412, the method may include generating an automation script based on execution of the machine learning model on the graph data, and executing the test case based on the automation script.

In 413, the method may include retrieving relevant content associated with the testing targets from additional content and modifying the nodes in the graph model to include the relevant content associated with the testing targets, prior to retrieving the graph data. In 414, the method may include retrieving at least one of UI design features, data model features, and API features from at least one of text, images, video content, and audio content. In 415, the method may include generating a prompt with descriptions of the test case and relevant content to be used for the test case, and executing the machine learning model on the prompt to generate the test case. In 416, the method may include determining a correlation between a first testing target and a second testing target based on semantic analysis of the document, and establishing an edge between a first node in the graph model corresponding to the first testing target and a second node in the graph model corresponding to the second testing target.

Detailed descriptions of training a machine learning model and executing a machine learning model are further described and depicted herein.

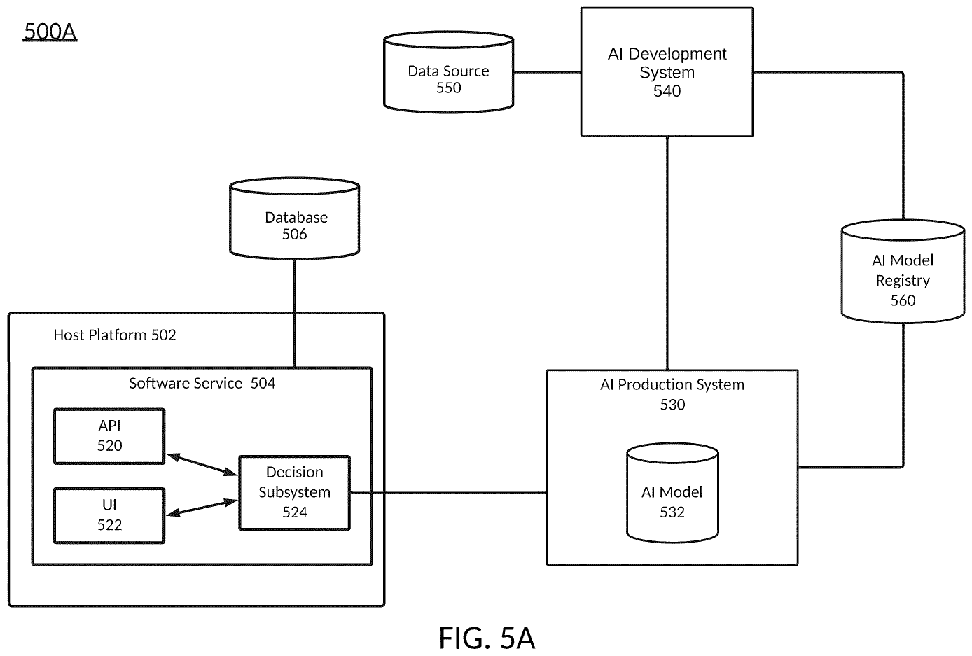

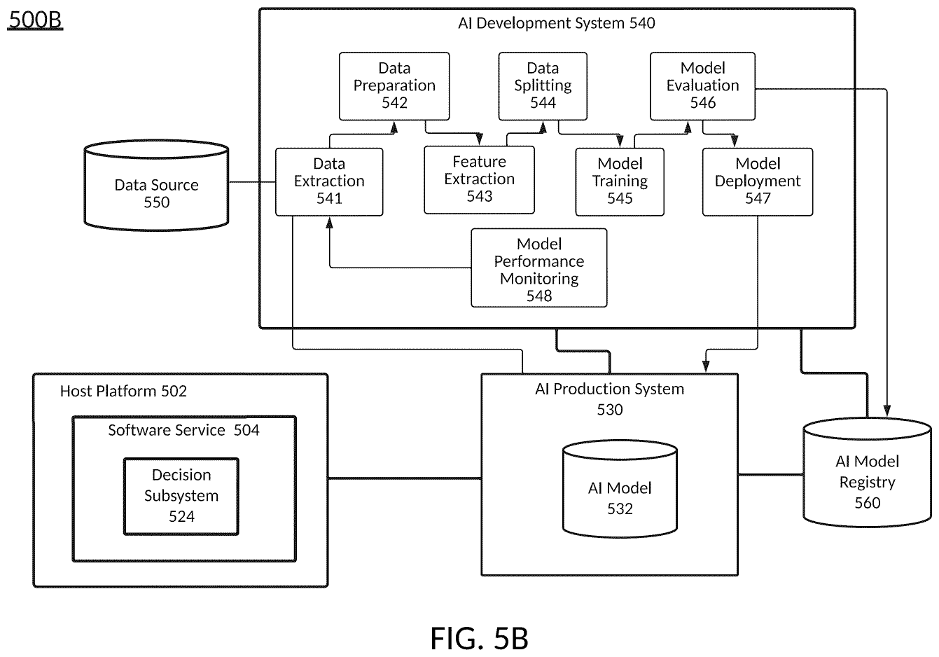

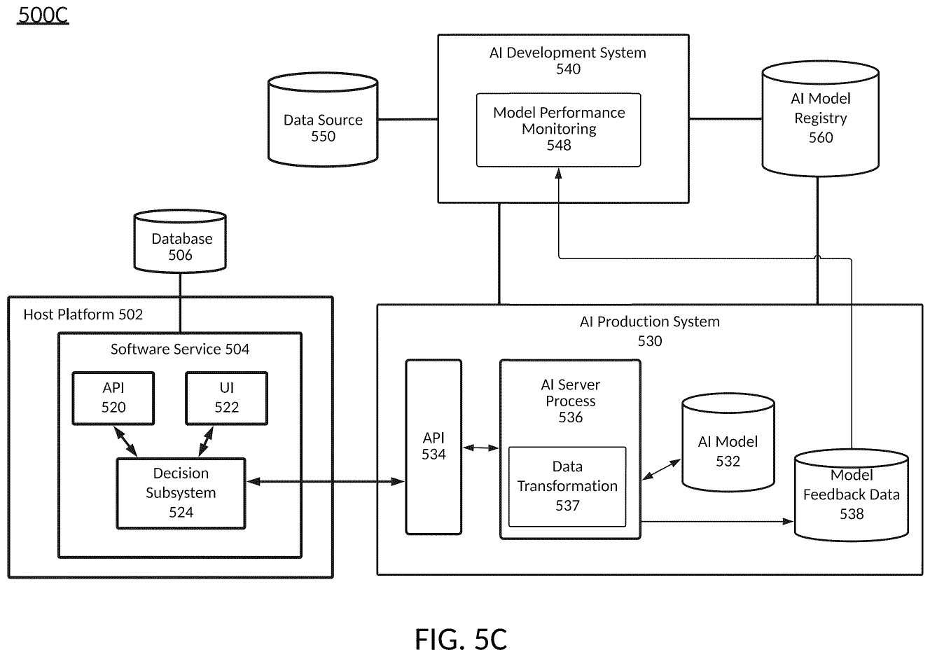

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a machine learning model, a neural network, a LLM, and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content—such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or creating entirely original pieces of art. Foundation models are established in the technology of natural-language processing. One example of how foundation models are helpful is that for previous generations of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/RoBERTa) and PaLM models. IBM has also recently launched its Granite model series on watsonx.ai™, which has become the generative AI backbone for other IBM products like watsonx Assistant™ and watsonx Orchestrate™.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks, thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a large corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive, and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

Retrieval augmented generation (RAG) is an architecture for optimizing the performance of an artificial intelligence (AI) model by connecting it with external knowledge bases. RAG helps large language models (LLMs) deliver more relevant responses at a higher quality. Generative AI (gen AI) models are trained on large datasets and refer to this information to generate outputs. However, training datasets are finite and limited to the information the AI developer can access—public domain works, internet articles, social media content and other publicly accessible data. RAG allows generative AI models to access additional external knowledge bases, such as internal organizational data, scholarly journals and specialized datasets. By integrating relevant information into the generation process, chatbots and other natural language processing (NLP) tools can create more accurate domain-specific content without needing further training. RAG empowers organizations to avoid high retraining costs when adapting generative AI models to domain-specific use cases. Enterprises can use RAG to complete gaps in a machine learning model's knowledge base so it can provide better answers.

The primary benefits of RAG include (a) Cost-efficient AI implementation and AI scaling; (b) Access to current domain-specific data; (c) Lower risk of AI hallucinations; (d) Increased user trust; (e) Expanded use cases; (f) Enhanced developer control and model maintenance; (g) Greater data security; and (h) Cost-efficient AI implementation and AI scaling. When implementing AI, most organizations first select a foundation model: the deep-learning models that serve as the basis for the development of more advanced versions. Foundation models typically have generalized knowledge bases populated with publicly available training data, such as internet content available at the time of training. Retraining a foundation model or fine-tuning it—where a foundation model is further trained on new data in a smaller, domain-specific dataset—is computationally expensive and resource-intensive. The model adjusts some or all of its parameters to adjust its performance to the new specialized data.

With RAG, enterprises can use internal, authoritative data sources and gain similar model performance increases without retraining. Enterprises can scale their implementation of AI applications as needed while mitigating cost and resource requirement increases. Generative AI models have a knowledge cutoff, the point at which their training data was last updated. As a model ages further past its knowledge cutoff, it loses relevance over time. RAG systems connect models with supplemental external data in real-time and incorporate up-to-date information into generated responses. Enterprises use RAG to equip models with specific information such as proprietary customer data, authoritative research and other relevant documents. RAG models can also connect to the internet with application programming interfaces (APIs) and gain access to real-time social media feeds and consumer reviews for a better understanding of market sentiment. Meanwhile, access to breaking news and search engines can lead to more accurate responses as models incorporate the retrieved information into the text-generation process.

Generative AI models such as OpenAI's GPT work by detecting patterns in their data, then using those patterns to predict the most likely outcomes to user inputs. Sometimes models detect patterns that don't exist. A hallucination or confabulation happens when models present incorrect or made-up information as though it is factual. RAG anchors LLMs in specific knowledge backed by factual, authoritative and current data. Compared to a generative model operating only on its training data, RAG models tend to provide more accurate answers within the contexts of their external data. While RAG can reduce the risk of hallucinations, it cannot make a model error-proof. Chatbots, a common generative AI implementation, answer questions posed by human users. For a chatbot such as ChatGPT to be successful, users need to view its output as trustworthy. RAG models can include citations to the knowledge sources in their external data as part of their responses. When RAG models cite their sources, human users can verify those outputs to confirm accuracy while consulting the cited works for follow-up clarification and additional information. Data storage is often a complex and siloed maze. RAG responses with citations point users directly toward the materials they need.

Software service 504 (see FIG. 5A), executing on host platform 502 (see FIG. 5A) may provide one or more of an application programming interface (API) 520 that enables interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more of a decision subsystem 524 of the software service 504 to assist in decision-making. In some examples and features of the instant solution, the software service 504 stores data included in the API requests or data generated during processing the API requests into one or more of a database 506 (see FIG. 5A).

Software service 504 may provide one or more UI 522, such as a server-side hosted GUI. In some examples and features of the instant solution, the UI 522 employs template-based frameworks, component-based frameworks, etc. In some examples and features of the instant solution, the UI 522 sends data to one or more of a decision subsystem 524 of the software service 504 to assist with decision-making. In some examples and features of the instant solution, the software service 504 stores data included in UI requests or data generated during processing the UI requests into one or more of a database 506.

Software service 504 may include one or more of a decision subsystem 524 that drives a decision-making process of the software service 504. In some examples and features of the instant solution, the decision subsystem 524 receives data from one or more of an API 520 as input into the decision-making process. In some examples and features of the instant solution, a decision subsystem 524 may receive data from one or more of a UI 522 as input to the decision-making process. A decision subsystem 524 may gather service configuration or historical execution data from one or more database 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI model 532 that is executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud-hosted. In some examples and features of the instant solution, the AI production system 530 is deployed in a distributed multi-node architecture.

An AI development system 540 creates one or more of an AI model 532. In some examples and features of the instant solution, the AI development system 540 utilizes data from one or more of a data source 550 to develop and train one or more AI model 532. The data source 550 may be local or a third-party data source. Further, the data provided by the data source may be real-world or synthetic. In some examples and features of the instant solution, the AI development system 540 utilizes feedback data from one or more of an AI production system 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more of an AI production system 530. The AI model registry 560 resides in a dedicated server in one example of the instant solution. In some examples and features of the instant solution, the AI model registry 560 is cloud-hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more of a data source 550. In some examples and features of the instant solution, historical model feedback data is extracted from one or more of an AI production system 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training is performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more of an AI production system 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more of a data source 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A computer-implemented method comprising:
extracting testing targets of a software system from a document that describes requirements of the software system;
generating a graph model which comprises nodes corresponding to the testing targets and edges between the nodes corresponding to correlations between the testing targets;
receiving a request to generate a test case for a testing target among the testing targets;
retrieving graph data from the graph model based on the testing target and executing a machine learning model on the graph data to generate the test case for the testing target; and
executing the test case on the software system to generate test results.

2. The computer-implemented method of claim 1, wherein the extracting the testing targets comprises executing the machine learning model on a predefined prompt and the document to identify functional requirements and non-functional requirements of the software system, and the generating the graph model comprises generating nodes in the graph model for the functional requirements and the non-functional requirements.

3. The computer-implemented method of claim 1, further comprising generating an automation script based on execution of the machine learning model on the graph data, wherein the executing the test case comprises executing the test case based on the automation script.

4. The computer-implemented method of claim 1, further comprising retrieving relevant content associated with the testing targets from additional content and modifying the nodes in the graph model to include the relevant content associated with the testing targets, prior to retrieving the graph data.

5. The computer-implemented method of claim 4, wherein the retrieving the relevant content comprises retrieving at least one of user interface design features, data model features, and API features from at least one of text, images, video content, and audio content.

6. The computer-implemented method of claim 1, further comprising generating a prompt with descriptions of the test case and relevant content to be used for the test case, wherein the executing the machine learning model further comprises executing the machine learning model on the prompt to generate the test case.

7. The computer-implemented method of claim 1, further comprising determining a correlation between a first testing target and a second testing target based on semantic analysis of the document, and establishing an edge between a first node in the graph model corresponding to the first testing target and a second node in the graph model corresponding to the second testing target.

8. A computer system comprising:
a processor set;
a set of one or more computer-readable storage media; and
program instructions, collectively stored in the set of one or more storage media, that cause the processor set to perform computer operations comprising:
extracting testing targets of a software system from a document that describes requirements of the software system;
generating a graph model which comprises nodes corresponding to the testing targets and edges between the nodes corresponding to correlations between the testing targets;
receiving a request to generate a test case for a testing target among the testing targets;
retrieving graph data from the graph model based on the testing target and executing a machine learning model on the graph data to generate the test case for the testing target; and
executing the test case on the software system to generate test results.

9. The computer system of claim 8, wherein the extracting the testing targets comprises executing the machine learning model on a predefined prompt and the document to identify functional requirements and non-functional requirements of the software system, and the generating the graph model comprises generating nodes in the graph model for the functional requirements and the non-functional requirements.

10. The computer system of claim 8, wherein the computer operations further comprise generating an automation script based on execution of the machine learning model on the graph data, wherein the executing the test case comprises executing the test case based on the automation script.

11. The computer system of claim 8, wherein the computer operations further comprise retrieving relevant content associated with the testing targets from additional content and modifying the nodes in the graph model to include the relevant content associated with the testing targets, prior to retrieving the graph data.

12. The computer system of claim 11, wherein the retrieving the relevant content comprises retrieving at least one of user interface design features, data model features, and API features from at least one of text, images, video content, and audio content.

13. The computer system of claim 8, wherein the computer operations further comprise generating a prompt with descriptions of the test case and relevant content to be used for the test case, wherein the executing the machine learning model further comprises executing the machine learning model on the prompt to generate the test case.

14. The computer system of claim 8, wherein the computer operations further comprise determining a correlation between a first testing target and a second testing target based on semantic analysis of the document, and establishing an edge between a first node in the graph model corresponding to the first testing target and a second node in the graph model corresponding to the second testing target.

15. A computer program product comprising:
a set of one or more computer-readable storage media; and
program instructions, collectively stored in the set of one or more computer-readable storage media, for causing a processor set to perform computer operations comprising:
extracting testing targets of a software system from a document that describes requirements of the software system;
generating a graph model which comprises nodes corresponding to the testing targets and edges between the nodes corresponding to correlations between the testing targets;
receiving a request to generate a test case for a testing target among the testing targets;
retrieving graph data from the graph model based on the testing target and executing a machine learning model on the graph data to generate the test case for the testing target; and
executing the test case on the software system to generate test results.

16. The computer program product of claim 15, wherein the extracting the testing targets comprises executing the machine learning model on a predefined prompt and the document to identify functional requirements and non-functional requirements of the software system, and the generating the graph model comprises generating nodes in the graph model for the functional requirements and the non-functional requirements.

17. The computer program product of claim 15, wherein the computer operations further comprise generating an automation script based on execution of the machine learning model on the graph data, wherein the executing the test case comprises executing the test case based on the automation script.

18. The computer program product of claim 15, wherein the computer operations further comprise retrieving relevant content associated with the testing targets from additional content and modifying the nodes in the graph model to include the relevant content associated with the testing targets, prior to retrieving the graph data.

19. The computer program product of claim 18, wherein the retrieving the relevant content comprises retrieving at least one of user interface design features, data model features, and API features from at least one of text, images, video content, and audio content.

20. The computer program product of claim 15, wherein the computer operations further comprise generating a prompt with descriptions of the test case and relevant content to be used for the test case, wherein the executing the machine learning model further comprises executing the machine learning model on the prompt to generate the test case.
